(19) United States
(12) Patent Application Publication
(10) Pub. No.: US 2024/0322204 A1
(43) Pub. Date: Sep. 26, 2024

(54) METHOD FOR OPERATING A FUEL CELL SYSTEM

(71) Applicant: Robert Bosch GmbH, Stuttgart (DE)

(72) Inventors: Jonas Breitinger, Stuttgart (DE); Matthias Rink, Herrenberg (DE)

(21) Appl. No.: 18/580,331

(22) PCT Filed: Jul. 7, 2022
(86) PCT No.: PCT/EP2022/068858

§ 371 Date: Jan. 18, 2024

(30) Foreign Application Priority Data
Jul. 23, 2021 (DE) 10 2021 207 908.3

(51) Int. Cl. H01M 8/0432; H01M 8/04302; H01M 8/0438; H01M 8/04537; H01M 8/04701

(52) U.S. Cl. CPC H01M 8/04358; H01M 8/04302; H01M 8/04417; H01M 8/04597; H01M 8/04723

(57) ABSTRACT

The invention relates to a method for operating a fuel cell system (100) comprising at least one stack (101) when starting the fuel cell system (100), in particular when during a cold start of the fuel cell system and/or start of the fuel cell system (100) under freezing conditions, in order to bring, in particular to adjust, a coolant temperature (TCoolIn) at the entry point into the stack (101) to a desired stagnation temperature (Ts), the method comprising the following steps:
predicting the stagnation temperature (Ts) of the coolant (KM) for various rotational speeds (N) of a coolant pump (31),
adjusting the rotational speed (N) of the coolant pump (31) so that the stagnation temperature (Ts) is above the desired value (Ts).

### BACKGROUND

The invention relates to a method for operating a fuel cell system with at least one stack during a start of the fuel cell system, in particular during a cold start of the fuel cell system, in order to bring, in particular to adjust, a coolant temperature at the entry point into the stack to a desired stagnation temperature. The invention further relates to a corresponding control unit and a corresponding computer program product.

Fuel cells are regarded as the mobility concept of the future because they only emit water as exhaust gas and enable fast refueling times. Fuel cells are usually stacked to form a stack. A fuel cell system can comprise at least one or more stacks. Fuel cells require air and fuel, e.g. hydrogen, for the chemical reaction. The waste heat from the stack is dissipated by means of a coolant circuit and released into the environment via a vehicle radiator.

A coolant is recirculated in the coolant circuit. The coolant is pumped through the stack using a coolant pump. A 3-way valve ensures that the vehicle radiator can be partially or fully bypassed. This is, e.g., important during the start-up phase.

When the fuel cell system is started (in particular below 0° C.), the stack should be warmed up as quickly as possible. A rapid warm-up ensures that no water or even ice accumulates, which would make it difficult or impossible to continue the start-up. However, the risk of icing is only averted when the coolant (at least in the bypass circuit) has been safely heated above 0° C. As a result, freezing conditions do not result when the coolant is pumped into the stack.

During starts under freezing conditions, the coolant is either heated externally to the stack or by the electrochemical reaction in the stack. As a result, the start-up process is prolonged in both cases.

### SUMMARY

The present invention provides: a method for operating a fuel cell system comprising at least one stack during a start-up of the fuel cell system, in particular during a cold start of the fuel cell system, in order to bring a coolant temperature at the entry point into the stack to a desired stagnation temperature, in particular to adjust it, by means of the features in the independent method claim. The invention further provides a corresponding control unit and a corresponding computer program having the features of the dependent claims. In this context, features and details described in connection with the various embodiments and/or aspects of the invention clearly also apply in connection with the other embodiments and/or aspects of the invention, and respectively vice versa, so, with respect to the disclosure, mutual reference to the individual embodiments and/or aspects of the invention is or can always be made.

According to the first aspect, the present invention provides: a method for operating a fuel cell system comprising at least one stack during a start and/or start of the fuel cell system under freezing conditions, in particular during a cold start of the fuel cell system, in order to bring, in particular to adjust, a coolant temperature at the entry point into the stack to a desired stagnation temperature.

The method comprises the following steps:
predicting (using a deterministic and/or model-based model of the system or by measuring the system) the stagnation temperature of the coolant for various rotational speeds of a coolant pump or depending on the rotational speed of the coolant pump,
adjusting the rotational speed of the coolant pump so that the stagnation temperature is above the desired value.

The method steps according to the invention can be performed in the specified order, or in an amended order. The method steps according to the invention can be performed simultaneously, at least in part concurrently, and/or sequentially.

The fuel cell system within the meaning of the invention can preferably be used for mobile applications, e.g. in vehicles, in particular fuel-powered vehicles. The fuel cell system within the meaning of the invention can be used as the main energy source for a vehicle. At the same time, however, it is also conceivable that the fuel cell system within the meaning of the invention can be used for an auxiliary drive and/or an auxiliary drive of a vehicle, e.g. a hybrid vehicle. The fuel cell system within the meaning of the invention can also be used for stationary applications, e.g. in generators.

The fuel cell system within the meaning of the invention can in this case comprise one or more stacks each having multiple stacked fuel cells and the associated functional systems comprising: media systems (air or cathode system, fuel or anode system, cooling system), as well as an electrical system. Preferably, the fuel cell system within the meaning of the invention can comprise multiple modules in the form of individual stacks having multiple stacked fuel cells.

The invention recognizes that, during a cold start and/or a start under freezing conditions (system temperatures and/or environment temperatures below 4° C., in particular below 0° C.), there is a slowdown in the rise of the coolant temperature at the entry point into the stack. A constant coolant temperature is briefly established at the entry point into the stack. This effect can be described as stagnation of the coolant temperature. The level at which the coolant temperature remains at entry point into the stack can be described as a stagnation temperature of the coolant within the meaning of the invention.

The occurrence of the briefly constant coolant temperature at the entry point into the stack, known as the stagnation temperature, is due to a thermal oscillation in the coolant circuit. Initially, very cold coolant enters the cells and is heated considerably by the heat produced by the reaction. At the same time, the stack can be operated with air depletion in order to achieve the highest possible heat production. It is in this case to be expected that the planar temperature distribution in the cells is initially inhomogeneous. As soon as the coolant is fed back into the cells after circulating through the coolant circuit, the temperature difference between the coolant and the heat source is significantly reduced. The heat flow then takes place mostly within the cell structures. However, the aim is for the coolant temperature to rise as continuously as possible in order to leave the temperature range below or around 0° C., which is critical for ice formation, as quickly as possible.

The invention can aim to ensure that the inflow of a cold coolant (below or around 0° C.) is kept as short as possible by predictive control of the rotational speed of the coolant pump, adapted to the environment temperature. As a result, the cold start phase can be significantly reduced, the risk of ice formation can be minimized, and degradation of the cells can be reduced.

The invention proposes that, by regulating the rotational speed of the coolant pump, the occurrence of stagnation of the coolant temperature at the entry point into the stack is shifted to temperature levels that reliably exclude further ice formation. In this way, conditions in which the coolant temperature at the entry point into the cell remains at undesirable temperatures below or around 0° C. for long periods of time, thus promoting possible ice formation, can be reliably avoided.

According to a further advantage of the method according to the invention, the volume of the coolant bypass circuit can already be dimensioned such that critical steady-state conditions can be reliably avoided during the start of fuel cells under freezing conditions.

The following advantages can be achieved using the invention:
reduction or even elimination of the risk of icing during a start under freezing conditions thanks to a control circuit in the coolant system.
reduction of the costs for the ice buffer measures in the stack and system and increase in the robustness of the start under freezing conditions.
a nearly constant heating rate of the coolant over time at the discharge point from the stack.
fast and efficient start under freezing conditions, as the heat input does not have to be reduced to prevent excessive temperature differences between the entry point into the stack and the discharge point from the stack.
increase of the service life of the stack.
targeted adjustment of the system design to avoid the problem.

A method can further provide that at least one of the following preparatory steps is performed in order to predict the stagnation temperature:
determining a circulation time of the coolant depending on the rotational speed of the coolant pump,
whereby, in particular a volume of a coolant circuit that bypasses a cooler and/or a volumetric flow of the coolant is/are taken into account when determining the circulation time of the coolant,
predicting when a first heated coolant packet will re-enter the stack after passing through the stack and the stagnation temperature will be reached by the coolant depending on the rotational speed of the coolant pump.

In this way, it is possible to calculate in advance when the heated coolant will re-enter the stack after passing through it and when the stagnation of the coolant temperature will occur at the entry point into the stack. The time before the coolant temperature stagnates at the entry point into the stack can be determined thereby. On the one hand, the time until the coolant temperature stagnates at the entry point into the stack can be used within regulation in the control system to shorten this time as much as possible with regard to the stagnation temperature by adjusting the rotational speed of the coolant pump accordingly. On the other hand, the time until the coolant temperature stagnates at the entry point into the stack can be used to determine a heat input (i.e., the heat input until stagnation) into the coolant by the chemical reaction in the stack for the prediction of the stagnation temperature based on a model, in particular to calculate it deterministically.

Furthermore, a method can provide that a heat input into the coolant due to the chemical reaction in the stack is taken into account when predicting the stagnation temperature. It is advantageous to take into account that the heat input into the coolant essentially takes place until the coolant temperature stagnates at the entry point into the stack. The heat input can, on the one hand, be calculated based on a model and, on the other hand, by measuring the temperatures of the coolant at the entry point or discharge point from the stack.

On the one hand, the heat input into the coolant can be calculated by measuring the coolant temperature at the entry point into the stack and/or measuring a coolant temperature at a discharge point from the stack. Therefore, the heat input can be calculated by measuring the temperatures of the coolant at the entry point into and/or discharge point from the stack.

On the other hand, the heat input into the coolant can be calculated by modeling the coolant temperature at the entry point into the stack and/or modeling a coolant temperature at a discharge point from the stack. When modeling the coolant temperature, an electrical current, an electrical voltage, and/or at least one thermal characteristic of a coolant circuit, such as heat capacity, density, etc., can be taken into account. In this way, the heat input can be calculated by means of modeling.

The method can further comprise at least one additional step:
monitoring the coolant temperature at the entry point into the stack,
continuing a start-up process of the fuel cell system when the coolant temperature at the entry point into the stack has reached the desired stagnation temperature,
reducing the rotational speed of the coolant pump if the coolant temperature at the entry point into the stack is below the desired stagnation temperature, and/or
increasing the rotational speed of the coolant pump if the coolant temperature at the entry point into the stack is above a permissible range, in particular above 0° C. to 10° C., preferably above 2° C. to 8° C., preferably above 4° C. to 7° C., for the desired stagnation temperature.

In this way, the regulation of the coolant temperature depending on the rotational speed of the coolant pump can be provided as a manipulated variable in order to bring the coolant temperature at the entry point into the stack to a desired stagnation temperature, and in particular to adjust it as quickly as possible. The rotational speed of the coolant pump is in this case used as the control variable.

The method can also comprise at least one further step:
monitoring the heat input during a start-up process of the fuel cell system, continuing the start-up process if the heat input is within a permissible range, in particular from 0% to 5%, preferably from 0% to 2%, preferably from 0% to 1%,
repeating the method according to one of the preceding claims if the heat input is above a permissible range, in particular above 1%, preferably above 2%, preferably above 5%.

In this way, it can be ensured that the forecast is checked for plausibility and corrected in the event of unexpected deviations.

Advantageously, the method can be initiated when a start-up of the fuel cell system is planned and when a system temperature and/or an environment temperature is or is expected to be below the permissible range, in particular below 0° C., preferably below 2° C., preferably below 4° C.

According to one particular advantage of the invention, the method can be used for the design of the fuel cell system, in particular the coolant circuit, e.g. the length of the coolant bypass circuit, and/or heat-transferring surfaces in the fuel cell system, e.g. the bipolar plates and/or gas diffusion layers,
so that the coolant temperature at the entry point into the stack reaches the desired stagnation temperature quickly and/or efficiently, and/or
so that the temperature difference of the coolant between the entry point into the stack and discharge point from the stack does not exceed a permissible upper limit.

In this way, the method can be used to ensure that the system is already designed so that stagnation of the coolant temperature reliably takes place within the safe range, even without the need to regulate the coolant temperature using the rotational speed of the coolant pump as a control variable.

In order to yet further refine the method, the method can comprise at least one further control variable in addition to the rotational speed of the coolant pump in order to bring, in particular to adjust, the coolant temperature at the entry point into the stack to the desired stagnation temperature:
an electrical current,
the mass flow of an oxidizing agent, and/or
the mass flow of a fuel.

The method can also be performed at least in part by a control unit of the fuel cell system. A corresponding control unit provides a further aspect of the invention. A computer program can be stored in a memory unit of the control unit in the form of a code, which, when the code is executed by a computing unit of the control unit, performs a method that can proceed as described hereinabove. Using the control unit according to the invention, the same advantages can be achieved as described hereinabove in connection with the method according to the invention. In the present case, reference to these advantages is made in full.

The control unit can communicate with the sensors in the functional systems of the fuel cell system in order to monitor the sensor values.

The control unit can control the actuators in the functional systems of the fuel cell system in order to perform the method accordingly.

In addition, the control unit can be in a communication link with an external computing unit in order to outsource some method steps and/or calculations, in whole or part, to the external computing unit.

According to a further aspect, the invention provides a computer program product comprising instructions that, when the computer program is executed by a computer, e.g., the computing unit of the control unit, prompts the computer to perform the method, which can proceed as described hereinabove. Using the computer program product, the same advantages can be achieved as described above in connection with the method according to the invention and/or the control unit according to the invention. In the present case, reference to these advantages is made in full.

### BRIEF DESCRIPTION OF THE DRAWINGS

The invention and the embodiments as well as the advantages thereof are explained in further detail below with reference to the drawings. Schematically shown are:

FIG. 1 an exemplary fuel-cell system in the context of the invention,

FIG. 2 typical temperature curves of coolant and cathode air during a start under freezing conditions, and

FIG. 3 an exemplary sequence of a method according to the invention.

### DETAILED DESCRIPTION

In the various drawings, identical aspects of the invention are always indicated by identical reference characters, for which reason said parts are typically only described once.

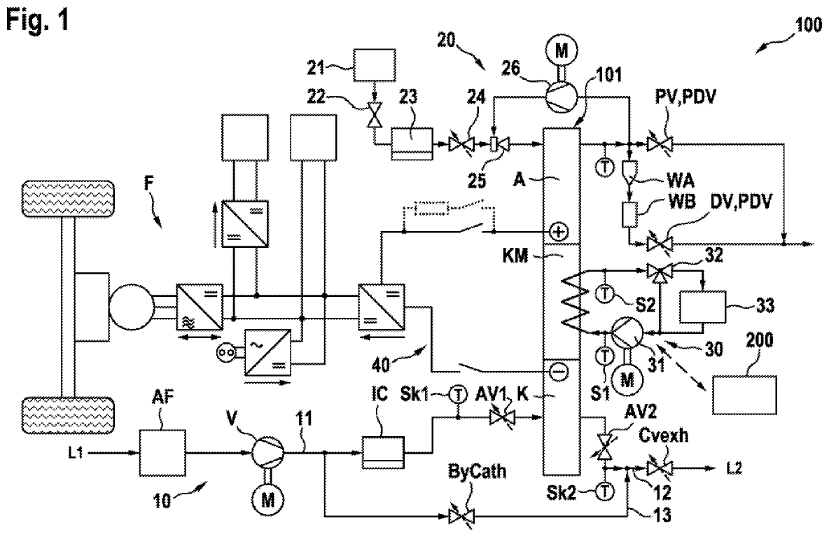

FIG. 1 shows an exemplary fuel cell system 100 within the scope of the invention. The fuel cell system 100 usually comprises multiple fuel cells, which are joined together to form a fuel cell stack 101. A cathode path K, an anode path A and a path for a coolant KM are routed through the stack 101. The fuel cell system 100 can also be modular in design and have multiple stacks 101.

The fuel cell system 100 further comprises at least four functional systems 10, 20, 30, 40, including: a cathode system 10 for supplying a cathode chamber or the cathode path K of the stack 101 with an oxidizing agent or cathode air, an anode system 20 for supplying an anode chamber or the anode path A of the stack 101 with a fuel, e.g. hydrogen H2, a cooling system 30 for tempering the stack 101, and an electrical system 40 to dissipate the generated electrical power from the stack 101 and feed it to, e.g., an on-board electrical system of a vehicle F.

The fuel cell system 100 therefore comprises a cathode system 10 with a supply air line 11 to the stack 101 and an exhaust air line 12 from the stack 101. An air filter AF is usually arranged at the inlet of the supply air line 11 in order to filter harmful chemical substances and particles or to prevent their entry into the system 100.

A gas conveying machine V in the cathode system 10 can be designed in the form of a compressor in order to draw in the air from the environment and supply it to the stack 101 in the form of a supply air L1. After passing through the stack 101, an exhaust air L2 is discharged from the system 100 back into the environment U.

As FIG. 1 indicates, at least one supply air cooler IC and optionally a humidifier (not shown) can be provided downstream of the compressor.

Shut-off valves AV1, AV2 can be provided upstream and downstream of the stack 101. In addition, a valve CVexh can be provided as a pressure regulator in the exhaust air line 12.

Temperature sensors Sk1, Sk2 can be provided before entering the stack and after being discharged from the stack.

A bypass line 13 comprising a bypass valve 16 can be provided between the supply air line 11 and the exhaust air line 12. The bypass line 13 can advantageously be used for mass flow control in the cathode system 10 and/or for diluting the exhaust air, which can contain hydrogen, from the stack 101.

The anode system 20 comprises multiple components. The components used to supply fuel include a fuel tank 21, a shut-off valve 22, and at least one pressure reduction valve 24. Optionally, a heat exchanger 23 can be provided in the anode system 20 downstream of the shut-off valve 22.

Further components in the anode system 20, which cause the anode gas to recirculate in the anode circuit, are a jet pump 25 and a recirculation fan 26.

In addition, a purge valve PV, and/or a drain valve DV, and/or a combined purge/drain valve PDV can be provided in the anode system 20. In addition, a water separator WA and optionally a water tank WB can be provided in the anode system 20.

The coolant system 30 comprises a coolant circuit, in which a coolant is recirculated with the aid of a coolant pump 31. A 3-way valve 32 can direct the coolant via a bypass at least partially or completely past a vehicle radiator 33.

To perform the method, the 3-way valve 32 to the vehicle radiator 33 is closed so that the coolant KM flows via the bypass and past the vehicle radiator 23 through a coolant bypass circuit.

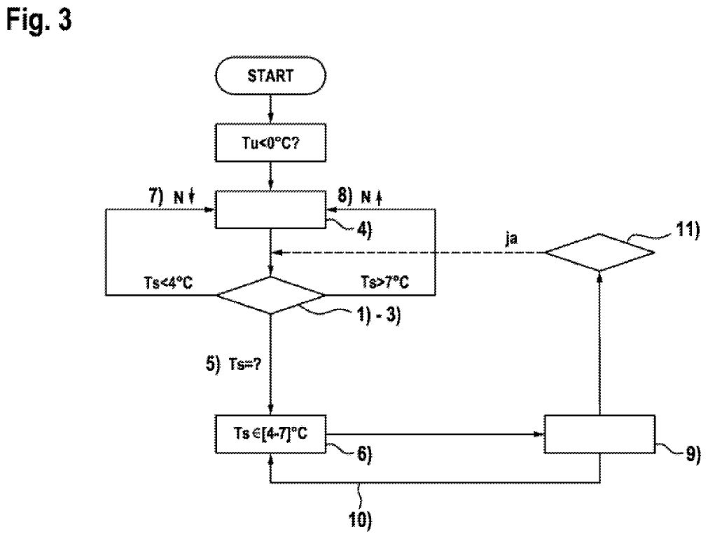

An exemplary sequence of a method within the meaning of the invention is shown in FIG. 3 and is used to operate a fuel cell system 100 comprising at least one stack 101, in particular during a start of the fuel cell system 100, preferably during a cold start and/or start of the fuel cell system 100 under freezing conditions, in order to bring, in particular to adjust, a coolant temperature TCoolIn at the entry point into the stack 101 to a desired stagnation temperature Ts as quickly and efficiently as possible.

The method comprises the following steps:
3) predicting (using a deterministic and/or model-based model of the system or by measuring the system) the stagnation temperature Ts of the coolant KM for different rotational speeds N of a coolant pump 31 or depending on the rotational speed N of the coolant pump 31,
4) adjusting the rotational speed N of the coolant pump 31 so that the stagnation temperature Ts is above the desired value Ts.

The prediction of the stagnation temperature Ts of the coolant KM for different rotational speeds N of a coolant pump 31 using a deterministic and/or model-based model of the system 100 is explained below using steps 1), 2) and 3).

The prediction of the stagnation temperature Ts of the coolant KM for different rotational speeds N of a coolant pump 31 by measuring the system 100 can be stored in the form of a characteristic curve field.

The environment temperature Tu can be taken into account when predicting the stagnation temperature Ts. The prediction of the stagnation temperature Ts can in particular be made for various environment temperatures Tu and various rotational speeds N of a coolant pump 31.

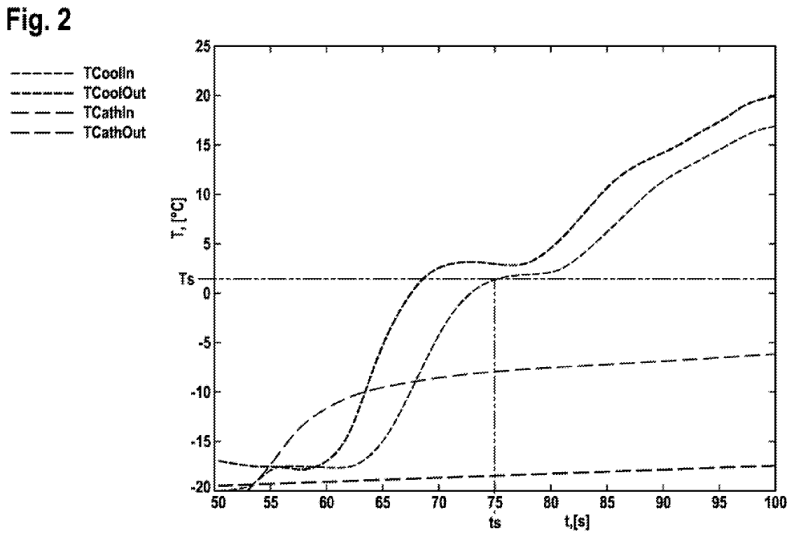

As shown in FIG. 2, in reference to a start measurement under freezing conditions at an ambient temperature of

T=−20° C., the coolant temperature rise at the cell entry point is slowed down and/or stagnated. A constant coolant temperature TCoolIn is in this case set for a short time, e.g. approximately 20 s, at the entry point into the stack 101. This effect can be described as a stagnation of the coolant temperature TCoolIn at the entry point into the stack 101. The level at which the coolant temperature TCoolIn remains at the entry point into the stack 101 can be described as a stagnation temperature Ts of the coolant KM.

The stagnation of coolant temperature TCoolIn at the entry point into stack 101 is caused by a coolant pack circulating through a coolant bypass circuit. First, very cold coolant KM enters the stack 101. In the stack 101, the coolant KM heats up quickly due to the heat production of the reaction. The stack 101 is often operated with air depletion during a cold start and/or start under freezing conditions in order to achieve the highest possible heat production. Initially, the planar temperature distribution in the cells is inhomogeneous. As soon as the coolant KM re-enters the stack 101 after circulating through the coolant bypass circuit, the temperature difference between the coolant KM and the heat source in the cells is significantly reduced. The heat flow then takes place mostly within the cell structures. However, the aim is to increase the coolant temperature as continuously as possible in order to leave the temperature range below or around 0° C., which is critical for ice formation, as quickly and efficiently as possible.

As illustrated in FIG. 3, in the context of the invention, the rotational speed N of the coolant pump 31 is adjusted as a manipulated variable when controlling the coolant temperature TCollIn in order to shift the occurrence of stagnation of the coolant temperature TCollIn at the entry point into the stack 101 to temperature levels that reliably rule out ice formation.

With the aid of the invention, the phase of a start under freezing conditions can be significantly shortened, the risk of ice formation minimized and the degradation of the stack 101 reduced.

As shown in FIG. 3, at least one of the following preparatory steps can be performed in order to predict the stagnation temperature Ts during step 3):
1) determining a circulation time t of the coolant KM depending on the rotational speed N of the coolant pump 31, whereby, in particular, a volume of a coolant circuit 30 that bypasses a cooler 33 and/or a volumetric flow of the coolant KM is/are taken into account when determining the circulation time t of the coolant KM,
2) predicting when a first heated coolant packet re-enters the stack 101 after passing through the stack 101 and the stagnation temperature Ts is reached by the coolant KM, depending on the rotational speed N of the coolant pump 31.

Therefore, depending on the rotational speed N of the coolant pump 31, it is possible to predict when the heated coolant will re-enter the stack 101 after passing through the stack 101 and when stagnation of the coolant temperature will occur at the entry point into the stack. The time ts until the coolant temperature TCoolIn stagnates at the entry point into the stack 101 can thus be determined.

On the one hand, the time ts until the coolant temperature TCoolIn stagnates at the entry point into the stack 101 can be used in the control system during regulation to shorten this time ts as much as possible (with regard to the permissible lower limit of the stagnation temperature Ts) by selecting the rotational speed N of the coolant pump 31 accordingly.

On the other hand, the time ts until stagnation of the coolant temperature TCoolIn at the entry point into the stack 101 can be used to determine a heat input (meaning the heat input until stagnation) ΔT into the coolant KM by the chemical reaction in the stack 101 for the prediction of the stagnation temperature Ts in step 3) on the basis of a model and/or to calculate it deterministically.

Furthermore, a method can provide that a heat input ΔT into the coolant KM due to the chemical reaction in the stack 101 is taken into account for the prediction of the stagnation temperature Ts. It can be taken into account that the heat input ΔT into the coolant KM essentially takes place until the coolant temperature stagnates at the entry point into the stack. The heat input ΔT can be determined based on a model or calculated deterministically on the one hand and calculated by measuring the temperatures of the coolant at the entry point and/or at the discharge point from stack on the other.

On the one hand, the heat input ΔT into the coolant KM can be calculated by measuring the coolant temperature TCoolIn at the entry point into the stack 101 and/or measuring a coolant temperature TCoolOut at a discharge point from the stack 101. Therefore, the heat input ΔT can be calculated by measuring the temperatures of the coolant at the entry point and/or discharge point from the stack.

On the other hand, the heat input ΔT into the coolant KM can be calculated by modeling the coolant temperature TCoolIn at the entry point into the stack 101 and/or modeling a coolant temperature TCoolOut at a discharge point from the stack 101. When modeling the coolant temperature TCoolOut, an electric current, an electric voltage and/or at least one thermal characteristic of a coolant circuit 30, such heat capacity, density, etc., can be taken into account. In this way, the heat input ΔT can be calculated by modeling.

As shown in FIG. 3, the method can comprise at least one further step:
5) monitoring the coolant temperature TCoolIn at the entry point into stack 101,
6) continuing a start-up process of the fuel cell system 100 when the coolant temperature TCoolIn at the entry point into the stack 101 has reached the desired stagnation temperature Ts,
7) reducing the rotational speed N of the coolant pump 31 if the coolant temperature TCoolIn at the entry point into the stack 101 is below the desired stagnation temperature Ts, and/or
8) increasing the rotational speed N of the coolant pump 31 if the coolant temperature TCoolIn at the entry point into the stack 101 is above a permissible range, in particular above 0° C. to 10° C., preferably above 2° C. to 8° C., preferably above 4° C. to 7° C., for the desired stagnation temperature Ts.

In this way, a control circuit can be provided for regulating the coolant temperature TCoolIn at the entry point into the stack 101 depending on the rotational speed N of the coolant pump 31. The control system can thereby reliably ensure that the coolant temperature TCoolIn at the entry point into the stack 101 is quickly and efficiently brought to a desired stagnation temperature Ts, and in particular that said temperature is adjusted as quickly as possible.

As shown in FIG. 3, the method can further comprise at least one further step:
9) monitoring the heat input ΔT during a start-up process of the fuel cell system 100,
10) continuing the start-up process if the heat input ΔT is within a permissible range, in particular from 0% to 5%, preferably from 0% to 2%, preferably from 0% to 1%,
11) repeating the method according to one of the preceding claims, in particular steps 1) through 3) and 4), if the heat input (ΔT) is above a permissible range, in particular above 1%, preferably above 2%, preferably above 5%.

In this way, additional certainty can be created and the plausibility of the forecast can be checked.

As FIG. 3 also shows, the method can be initiated when a start of the fuel cell system 100 is planned and when a system temperature and/or an environment temperature Tu is or is expected to be below the permissible range, in particular below 0° C., preferably below 2° C., preferably below 4° C.

The numbers shown in FIG. 3 are merely by way of example. Rather, the numbers and/or ranges can be adjusted, at least as shown above using steps 8), 10), and/or 11).

Advantageously, the method, which can proceed as described hereinabove, can be used for the design of the fuel cell system, in particular the coolant circuit 30, e.g. the length of the coolant bypass circuit, and/or heat transferring surfaces in the fuel cell system 100, e.g. the bipolar plates and/or gas diffusion layers,
so that the coolant temperature TCoolIn at the entry point into the stack 101 reaches the desired stagnation temperature Ts quickly and/or efficiently and/or
so that a temperature difference of the coolant KM between the entry point into the stack 101 and a discharge point from the stack 101 does not exceed a permissible upper limit.

In order to yet further refine the method, the method can comprise at least one further control variable in addition to the rotational speed N of the coolant pump 31 in order to bring the coolant temperature TCoolIn at the entry point into the stack 101 to the desired stagnation temperature Ts, in particular to adjust it:
an electrical current,
the mass flow of an oxidizing agent, and/or
the mass flow of a fuel.

A corresponding control unit 200, which is schematically indicated in FIG. 1, provides a further aspect of the invention. A computer program in the form of a code can be stored in a memory unit of the control unit 200, which, when the code is executed by a computing unit of the control unit 200, performs a method which can proceed as described hereinabove.

The control unit 200 can be in a communication link with the sensors in the functional systems of the fuel cell system 100 in order to monitor the sensor values.

The control unit 200 can control the actuators in the functional systems 10, 20, 30, 40 of the fuel cell system 100 accordingly in order to perform the method as described hereinabove.

Optionally, the control unit 200 can be in a communication connection with an external computing unit in order to outsource some method steps and/or calculations in whole or in part to the external computing unit.

The description hereinabove of the drawings merely describes the present invention by way of examples. Of course, individual features of the embodiments can be freely combined with one another, insofar as technically sensible, without departing from the scope of the invention.

1. A method for operating a fuel cell system (100) comprising at least one stack (101) when starting the fuel cell system (100) under freezing conditions, to bring a coolant temperature (TCoolIn) at an entry point into the stack (101) to a desired stagnation temperature (Ts), the method comprising the following steps:
predicting the stagnation temperature (Ts) of the coolant (KM) for various rotational speeds (N) of a coolant pump (31), and
adjusting the rotational speed (N) of the coolant pump (31) so that the stagnation temperature (Ts) is above the desired value (Ts).

2. The method according to claim 1,
wherein
at least one of the following preparatory steps is performed to predict the stagnation temperature (Ts):
determining a circulation time (t) of the coolant (KM) depending on the rotational speed (N) of the coolant pump (31),
wherein a volume of a coolant circuit that bypasses a cooler (33) and/or a volumetric flow of the coolant (KM) is/are taken into account,
predicting when a first heated coolant packet re-enters the stack (101) after passing through the stack (101), and the stagnation temperature (Ts) is reached by the coolant (KM) depending on the rotational speed (N) of the coolant pump (31).

3. The method according to claim 1,
wherein
a heat input (ΔT) into the coolant (KM) due to the chemical reaction in the stack (101) is taken into account when predicting the stagnation temperature (Ts).

4. The method according to claim 3,
wherein
the heat input (ΔT) into the coolant (KM) is calculated by measuring the coolant temperature (TCoolIn) at the entry point into the stack (101) and/or measuring a coolant temperature (TCoolOut) at a discharge point from the stack (101),
and/or that the heat input (ΔT) into the coolant (KM) is calculated by modeling the coolant temperature (TCoolIn) at the entry point into the stack (101) and/or modeling a coolant temperature (TCoolOut) at a discharge point from the stack (101),
wherein an electric current, an electric voltage, and/or at least one thermal characteristic of a coolant circuit is/are taken into account.

5. The method according to claim 1,
wherein
the method comprises at least one further step:
monitoring the coolant temperature (TCoolIn) at the entry point into the stack (101),
continuing a start-up process of the fuel cell system (100) when the coolant temperature (TCoolIn) at the entry point into the stack (101) has reached the desired stagnation temperature (Ts),
reducing the rotational speed (N) of the coolant pump (31) if the coolant temperature (TCoolIn) at the entry point into the stack (101) is below the desired stagnation temperature (Ts), and/or
increasing the rotational speed (N) of the coolant pump (31) if the coolant temperature (TCoolIn) at the entry point into the stack (101) is above a permissible range for the desired stagnation temperature (Ts).

6. The method according to claim 1,
wherein the method comprises at least one further step:
monitoring the heat input (ΔT) during a start-up process of the fuel cell system (100),
continuing the start-up process if the heat input (ΔT) is within a permissible range,
repeating the method according to claim 1 if the heat input (ΔT) is above a permissible range.

7. The method according to claim 1,
wherein
the method is initiated when a start of the fuel cell system (100) is planned and when a system temperature and/or an environment temperature (Tu) is below the permissible range.

8. The method according to claim 1,
wherein
the method is used for the design of the fuel cell system (100), in particular the coolant circuit and/or the heat transferring surfaces in the fuel cell system (100),
so that the coolant temperature (TCoolIn) at the entry point into the stack (101) reaches the desired stagnation temperature (Ts) quickly and/or efficiently and/or
so that a temperature difference of the coolant (KM) between the entry point into the stack (101) and a discharge point from the stack (101) does not exceed a permissible upper limit,
and/or that the method comprises at least one further manipulated variable in addition to the rotational speed (N) of the coolant pump (31) to bring the coolant temperature (TCoolIn) at the entry point into the stack (101) to the desired stagnation temperature (Ts):
an electrical current,
the mass flow of an oxidizing agent, and/or
the mass flow of a fuel.

9. A control unit (200) comprising a memory-unit, in which a code is stored, and an electronic processor, wherein when the code is executed by the electronic processor operates a fuel cell system (100) comprising at least one stack (101) to bring a coolant temperature (TCoolIn) at an entry point into the stack (101) to a desired stagnation temperature (Ts), by:
predicting the stagnation temperature (Ts) of the coolant (KM) for various rotational speeds (N) of a coolant pump (31), and
adjusting the rotational speed (N) of the coolant pump (31) so that the stagnation temperature (Ts) is above the desired value (Ts).

10. A non-transitory, computer-readable medium containing instructions that, when executed by a computer cause the computer to operate a fuel cell system (100) comprising at least one stack (101) to bring a coolant temperature (TCoolIn) at an entry point into the stack (101) to a desired stagnation temperature (Ts), by:
predicting the stagnation temperature (Ts) of the coolant (KM) for various rotational speeds (N) of a coolant pump (31), and
adjusting the rotational speed (N) of the coolant pump (31) so that the stagnation temperature (Ts) is above the desired value (Ts).
